(19) United States
(12) Patent Application Publication
(10) Pub. No.: US 2014/0052854 A1
(43) Pub. Date: Feb. 20, 2014

(54) CONTENT DELIVERY WITH LIMITED FREE SERVICE BASED ON PARAMETERIZED BEHAVIORAL MODEL

(71) Applicant: Rdio, Inc., San Francisco, CA (US)

(72) Inventors: Andrew Larner, San Francisco, CA (US); Craig Kimerer, San Francisco, CA (US); Malthe Sigurdsson, San Anselmo, CA (US); Wilson Miner, San Francisco, CA (US); Brian Park, Santa Monica, CA (US); Todd Jason Berman, San Francisco, CA (US)

(73) Assignee: RDIO, INC., San Francisco, CA (US)

(21) Appl. No.: 14/061,274

(22) Filed: Oct. 23, 2013

Related U.S. Application Data
(63) Continuation of application No. PCT/US12/34839, filed on Apr. 24, 2012.
(60) Provisional application No. 61/478,999, filed on Apr. 26, 2011.

(51) Int. Cl. H04L 12/26

(52) U.S. Cl. CPC H04L 43/08
USPC 709/224

(57) ABSTRACT

A user is allocated a first period of limited free access to content; the user's activity during the first period is monitored; and the user is assigned to a particular cohort based on the user's activity during the first period. Each cohort prescribes one or more conditions governing additional free access by users assigned to that cohort. The user is allocated a usage allowance based on the conditions prescribed in the cohort to which the user was assigned; and the user's actual usage is enforced according to the conditions prescribed in that cohort. After a time period prescribed by that cohort, the user is given an opportunity to become a subscriber to the system. If the user does not become a subscriber then the user's usage allowance is adjusted based on conditions prescribed in that cohort.

### RELATED APPLICATIONS

This application is a continuation of application No. PCT/US2012/034839, titled “Content delivery with limited free Service based on Parameterized Behavioral Model,” filed Apr. 24, 2012, which is based on and claimed priority to U.S. Provisional Patent Application No. 61/478,999, filed Apr. 26, 2011, the entire contents of both of which are fully incorporated herein by reference for all purposes.

### BACKGROUND OF THE INVENTION

1. Copyright Statement

This patent document contains material subject to copyright protection. The copyright owner has no objection to the reproduction of this patent document or any related materials in the files of the United States Patent and Trademark Office, but otherwise reserves all copyrights whatsoever.

2. Field of the Invention

This invention relates to subscription to a service, and to methods and devices associated therewith. More particularly, this invention relates to a subscription approach for content delivery, with initial free service based on a parameterized behavioral model.

3. Background and Overview

Online sites are ubiquitous on the Internet, providing pictures, videos, movies, music, books and other forms and combinations of content. Much content was initially offered for free, sometimes even without permission from the contents' owners. Today many web sites require some form of registration, and many require payment. In some cases, the payment is a fixed fee, payable at regular intervals (e.g., monthly). In other cases, a one time fee may be charged.

While users seek out free content, web site owners/operators try to get users to pay for content. Many web sites offer limited time free content to users in order to entice those users to subscribe to their content. Typically the free content consists of shortened or edited versions of the actual content. For example, a web site providing audio content may provide 20 second audio clips for free, but require payment for actual content. Or a web site providing videos may provide an abridged video clip as a “teaser”, requiring the user to pay of the entire video.

However, because of competition and because there is still some free (albeit possibly unauthorized) content on available, many users tend to use only free sites. As soon as a web site requires subscription or payment, the users move on to other sites for their content.

### SUMMARY OF THE INVENTION

This invention provides, in some aspects, a system to encourage users to subscribe to a service. A subscription approach is based, at least in part, on a parameterized behavioral model of each user.

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a logical depiction of a fee-based online content distribution system;

FIG. 2(a) is a physical description of an exemplary environment of the system of FIG. 1;

FIG. 2(b) shows a typical computer in the system;

FIG. 3 is flowchart of operation of aspects of the system of FIG. 1;

FIGS. 4(a)-4(f) show graphs of exemplary cohort schemes.

### DETAILED DESCRIPTION OF THE PRESENTLY PREFERRED EXEMPLARY EMBODIMENTS

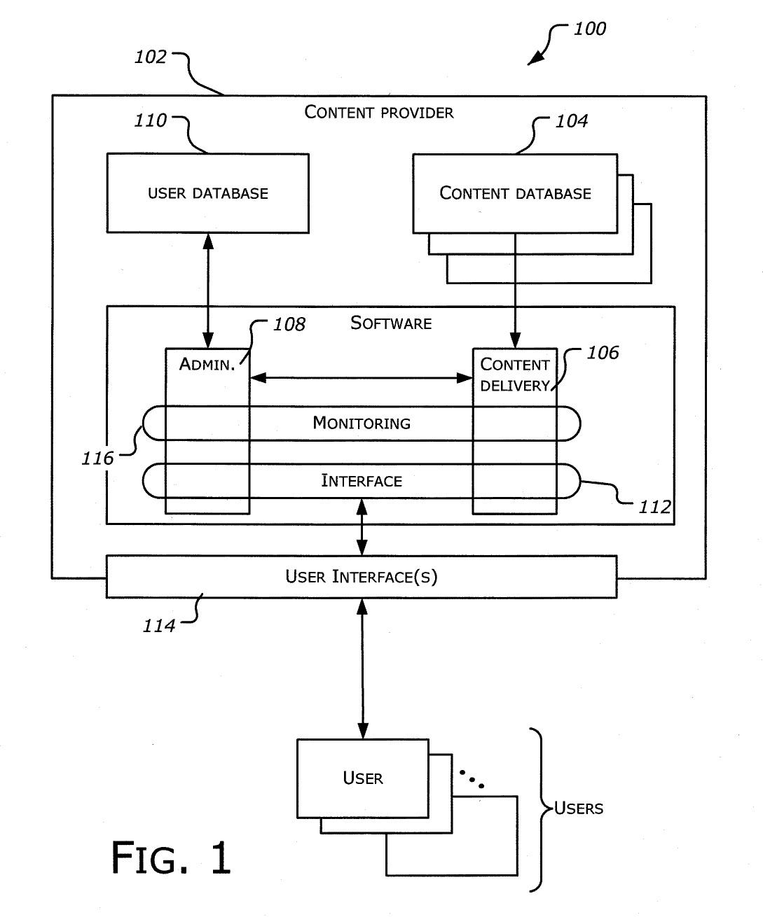

FIG. 1 shows fee-based online content distribution system 100. The content distribution system 100 is operated by or on behalf of a content provider 102, and includes one or more content databases 104 containing content for delivery via content delivery software 106. Those of skill in the art will realize and understand, upon reading this description, that the content databases 104 may be distributed in various locations and may be operated by other entities.

Administrative software 108 controls various aspects of the distribution system 100, including user (subscriber) registration, payment, monitoring and the like. Those of skill in the art will realize and understand, upon reading this description, that administrative software 108 may interface with external systems (not show) to perform certain functions such as billing and the like.

The administrative software 108 interfaces with various databases, collectively referred to as a user database 110. For the sake of explanation of this system 100, a distinction is sometimes made herein between users who have registered with the system but not yet subscribed and those users who have subscribed. For the purpose of this description, we generally refer to users who have paid (in some form) to use the system as “subscribers.” Users who have registered with the system but have not yet become subscribers are referred to as “registered users.” Users who have not yet registered are referred to as “users.” Where no distinction is made between types of users, the meaning will be apparent to those of skill in the art, from the context of the term. The user database 110 preferably includes records relating to users of the system, including subscribers and registered users.

As used herein the term “content” refers to any kind of digital content or service, including, without limitation, audio content (e.g., books, music, podcasts and the like), video content (e.g., movies, videos, and the like), and any other content that may be delivered to the user (e.g., images, text, and the like). The term “content,” as used herein, is not limited to the form or format of the content. The content may be static or dynamic, pre-recorded or live.

The content distribution system 100 includes interface software 112 supporting a user interface 114 to various aspects of the system, including administrative aspects and content delivery aspects. The user interface 114 may be via a web site accessed by a user's browser or the like. The system may provide and support multiple interfaces, allowing access via the Internet, proprietary networks, mobile devices, and the like. While the remainder of this description may refer to a user's web access to the system 100 over the Internet via a particular web site, those of skill in the art will realize and understand, upon reading this description, that the manner in which the system is accessed can vary without modifying the scope of the invention.

The system 100 includes monitoring software 116 to monitor content delivery on behalf of a particular user. The information gathered/measured by the monitoring software may include the actual content selected by the user, the amount of content delivered to the user, the time of delivery, etc. The amount of content may be measured in a number of ways, e.g., by the number of streams, the total size of the content, and the like.

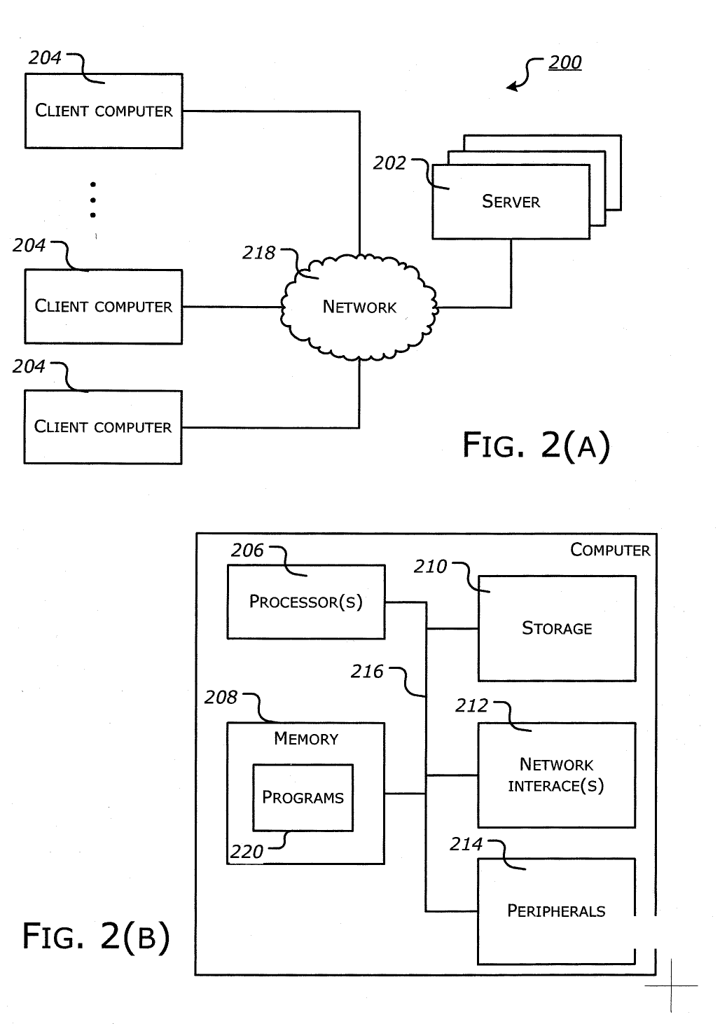

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system. FIG. 2(a) illustrates an example computer system 200 which includes one or more server computers 202 and client computers 204.

FIG. 2(b) illustrates a typical computer (e.g., server 202 or client 204), including, typically, a processor 206, memory 208, storage 210, and a network interface 212. The processor 206 (e.g., one or more microprocessors, one or more microcontrollers, one or more digital signal processors) receives instructions (e.g., from a memory 208 or like device), and executes those instructions, thereby performing one or more processes defined by those instructions. Instructions may be embodied in, e.g., one or more computer programs, one or more scripts. Aspects of these devices are described in greater detail below.

Thus, the content distribution system 100 may be implemented using one or more server computers 202, with one or more of the servers implementing the user interface 114 and providing access to the content distribution system's administrative functionality 108 and the content delivery functionality 106. In a presently preferred implementation, users access the content distribution system 100 via the network 218 using client computers 204. Those of skill in the art will realize and understand, upon reading this description, that the client computers 204 may be embodied in desktop computers, laptop computers, mobile devices, set-top boxes, and the like.

Registration and Subscription

It is desirable to have users subscribe to the content delivery system 100 and to pay for the content they receive from the system (i.e., to become paid subscribers). Each time a user accesses the system 100, the interface 114 provides the user with access to a login or registration option. Subscribers may login in some known manner and access content they have paid for. New users are given the option to become subscribers (preferably with various subscriber options), otherwise they are given controlled and limited free access to content, as described herein. In a presently preferred implementation the subscriber options include unlimited access to some or all of the content, and limited access to some or all of the content. Those of skill in the art will realize and understand, upon reading this description, that different subscriber options and pricing schemes may be offered to users who subscribe, including variations on the term of any subscription arrangement, the price, the amount or kind of content to be accessed, the locations at which the content may be accessed, the format in which content may be accessed, etc. A new user may be provided with some free content (e.g., “teaser” audio or video clips or thumbnail images), but the user is expected to register with the system, even if that user does not become a subscriber.

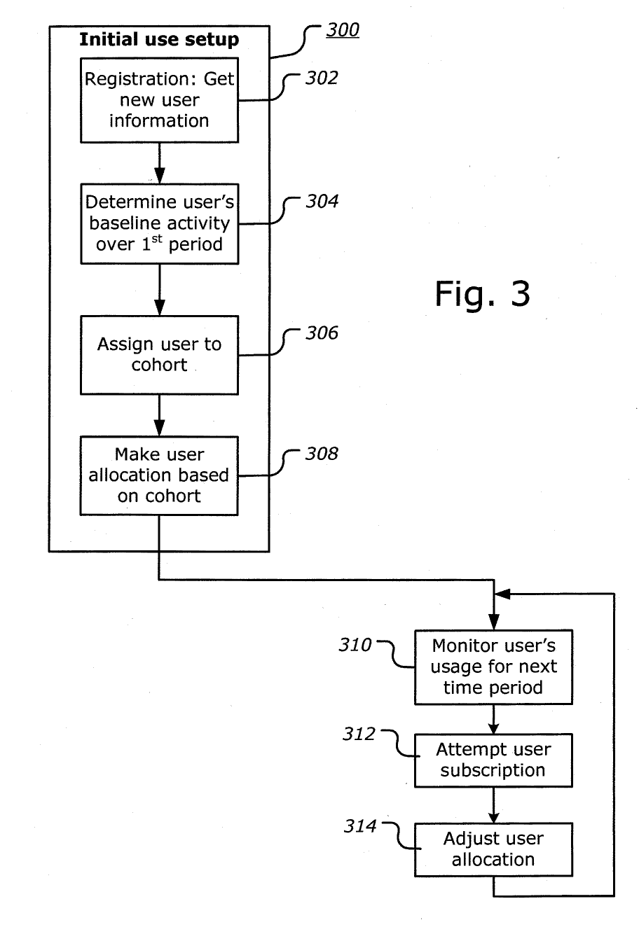

FIG. 3 is a flowchart showing operation of aspects of the content distribution system 100. The operations and acts shown and described in FIG. 3 are implemented, at least in part, by the administrative software 108 in conjunction with the content delivery software 106, running on one or more server computers 202. With reference now to the flowchart in FIG. 3, initial user setup 300 requires some form of user registration. The system preferably obtains sufficient and adequate information (at 302) to uniquely identify the new user. This information may be the user's email address or some other form of identifying information. The system 100 generally requires that the user's information be unique to that user, and the user information is used to create a user record in the user database 110. While the user's email address may be sufficient for some implementations, it is generally preferable to obtain some other information about the user (e.g., the user's age, sex, geographical location, income level, and the like) during or after the registration process. Some of this information may be obtained during the initial registration process and some may be obtained during subsequent interactions with the user.

The administrative software 108 preferably checks the user's provided information for consistency in a known manner.

Having registered (at 302), the system provides the user with free access to the content for a first period of time. In presently preferred implementations, this first period of time is seven days. During this first time period the user's access is monitored (by monitor 116) in order to determine a measure of the user's baseline activity over the first period (at 304). In a presently preferred implementation, the content comprises streaming music, and the user's baseline activity is measured by the number of streams the user accesses in the first period (seven days).

The registered user's baseline activity (determined at 304) is then used to assign the registered user to one of a plurality of cohorts or buckets (at 306). These various cohorts are used to determine the amount of additional free access the registered user will be provided. The term “cohort,” as used herein, refers to a group of users sharing one or more common characteristics. Each cohort uses a different allocation of time and/or content in order to try to encourage the registered user to become a subscriber. The registered user is then given a content allocation (e.g., number of streams per month) (at 308) in accordance with the conditions set forth in the user's assigned cohort. In presently preferred implementations the user's cohort defines both a content allowance (measured in streams per time period), and one or more time periods.

A registered user's current content allocation may include various restrictions and allowances, e.g., the user may be provided with unlimited access for any seven (7) days during the first month (not necessarily consecutive days), and then be cut off for the remainder of the month. Those of skill in the art will realize and understand, upon reading this description, that the invention is not limited by the complexity of the user's allocation and/or restrictions.

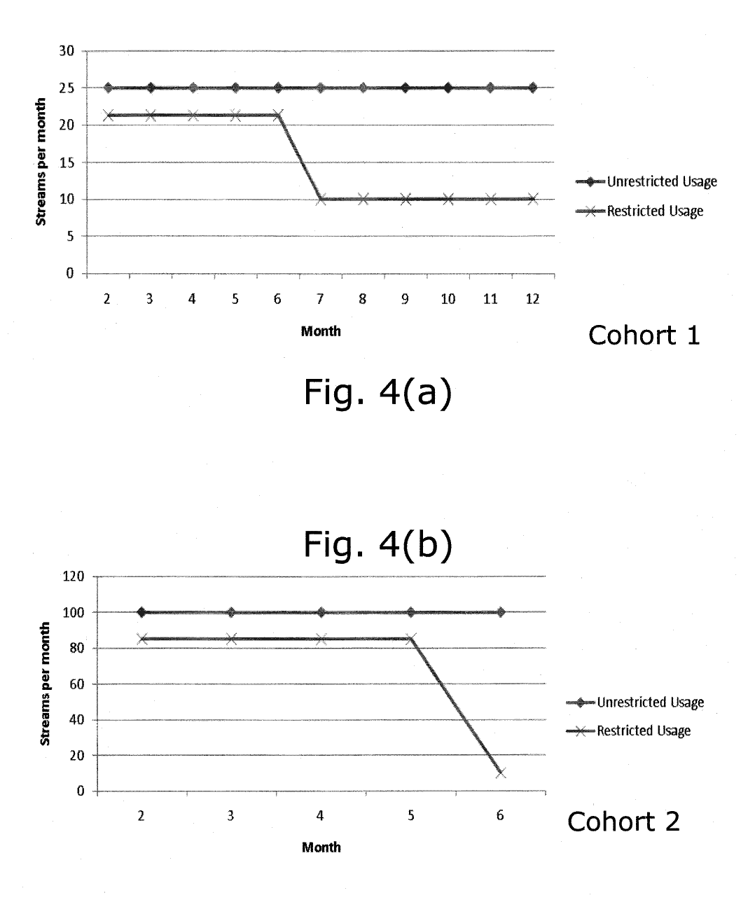

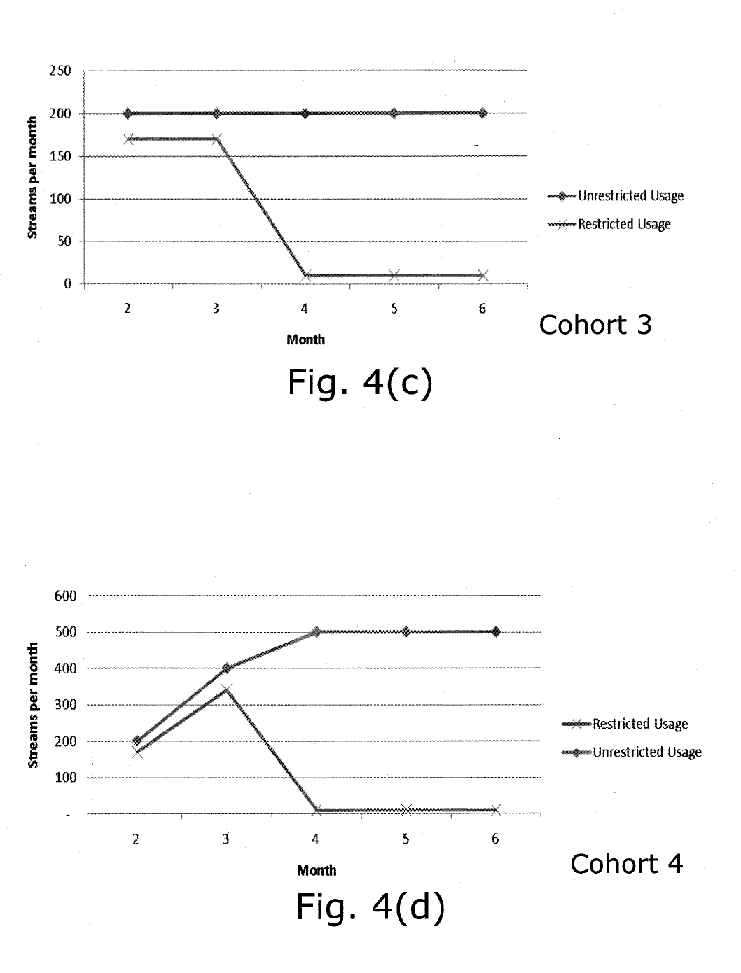

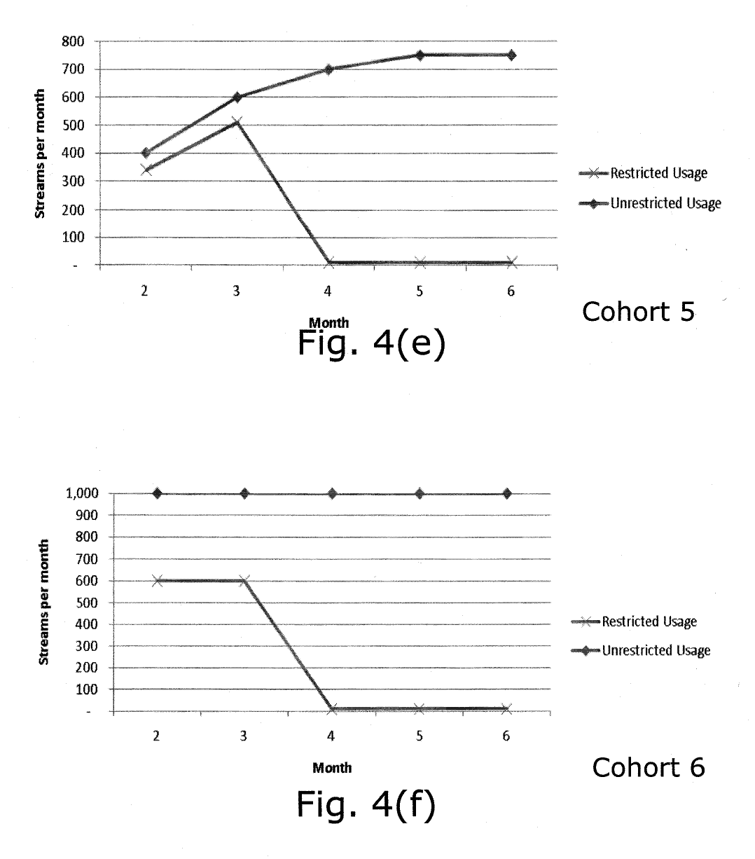

In a presently preferred implementation, there are six (6) cohorts, with parameters summarized in the following table and in the graphs in FIGS. 4(a)-4(f):

| | | | allocation |
|---|---|---|---|
| | | | (percentage |
| Cohort | unrestricted usage | restricted usage | of free users) |
| 1 | 25 streams per month | Reduced to 10 streams/ | 25 |
| | | month after month 6 | |
| 2 | 100 streams every | Over 300 cumulative in | 50 |
| | month | month 5; reduced to 10 | |
| | | streams for subsequent | |
| | | months | |
| 3 | 200 streams every | Hits usage cap in month | 15 |
| | month | 3; reduced to 10 streams | |
| | | for subsequent months. | |
| 4 | Starts at 100, doubles | Hits usage cap in month | 5 |
| | monthly until it | 3; reduced to 10 streams | |
| | reaches 500 where | for subsequent months | |
| | it remains monthly | | |
| 5 | starts at 100 and | Hits usage cap in month | 4 |
| | increases quickly | 3; reduced to 10 streams | |
| | to 750 where it | for subsequent months | |
| | remains monthly | | |
| 6 | 1,000 streams per | Hits 600 monthly cap in | 1 |
| | month | months 2 and 3; hits | |
| | | overall usage cap in | |
| | | month 3; reduced to 10 | |
| | | streams for subsequent | |
| | | months | |

FIGS. 4(a)-4(f) show graphs of the six exemplary cohort schemes described above. Each graph compares the usage allocation according to that cohort scheme with unrestricted usage. Those of skill in the art will realize and understand, upon reading this description, that the six cohort schemes shown are exemplary, and different schemes may be used, as may a different number of schemes.

Once the registered user is given an allocation (in 308), that allocation is implemented and enforced by the content provider 102 for that user. The registered user's usage is monitored for the next period of time (at 310), and the user's allocation is adjusted (at 312), based on the user's usage during the period and the user's cohort rules.

A registered user is preferably offered the option to become a subscriber each time the user logs in to the system. The registered user is also preferably offered the option of becoming a subscriber (at 312) each time the user's usage is adjusted.

In some implementations users may be provided with additional free access based on other factors such as the amount a user contributes to online review and discussions.

The user may be informed of his current free allocation, although this is not required.

Determining Cohorts

An exemplary system has been described here with six cohorts, each having a so-called degradation policy that steps down (or degrades) the user's allocation over one or more time periods. During the free period multiple attempts are made to convert the registered user into a subscriber.

Different cohorts may be determined based on a number of different factors, and different cohorts may be provided based on the sex of the user, for users in different geographical (or geo-political) regions, for different age groups, and for any other different factors.

Those of skill in the art will realize and understand, upon reading this description, that the number of cohorts and their membership criteria may change during a user's free period. A user may thus be assigned to a first cohort upon registration and then assigned to a different cohort during the free period. The user's cohort may be changed based on user-specific information and/or based on modification of the cohort criteria. For example, in one case there may initially be six cohorts, but that number may increase to thirty as refinements are made to the system. A user assigned to one of the initial six cohorts will then be reassigned to one of the thirty new cohorts. The system's interaction with the user will then follow the rules of the user's new cohort. In another example, a user may be initially assigned to one of ten cohorts based on some assumptions made about the user during the first week. As more time passes and the user uses the system more, it might become apparent that some of the assumptions were incorrect, and that user may be reassigned to a different cohort.

Assigning Users to Cohorts

As noted above, as used herein the term “cohort” refers to a group of users sharing one or more common characteristics. Each registered user is assigned to a cohort based, at least in part, on that user's activity during an initial free period (at 306). The user may also be assigned to a cohort based on other factors such as, e.g., the user's age, sex, geographical location, and the like. Some of these factors may be determined based on the user's response to queries during the registration process and during the initial free period. Other factors may be ascertained from other sources (e.g., the user's browser, network address information and the like).

Royalities

Typically the content provider 102 will have to pay royalties to the owners of the content being provided. Royalties are typically paid for delivered content. Those of skill in the art will realize and understand, upon reading this description, that different types of royalty schemes may be required in order to deliver free content to users, and the content provider 102 will need to arrange such royalty schemes with the content owners.

Payment

The system generally requires some form of payment from subscribers. Those of skill in the art will realize and understand, upon reading this description, that payment may be of any appropriate type and made in any manner, e.g., using a credit card, prepaid cards, online funds transfer, barter, rewards, and the like.

In some implementations, the system thus allows users to consume a fixed number of streams per month but vary the amount provided to each user based on that user's behavior in the first subsidized month of free use. The premise is to keep feeding each user a tailored amount of free consumption that is ratcheted back over time.

Computing

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system. As noted above, FIG. 2(a) illustrates an example computer system 200 which includes one or more server computers 202 and client computers 204, and FIG. 2(b) illustrates a typical computer (e.g., server 202 or client 204), including, typically, a processor 206, memory 208, storage 210, and a network interface 212.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

The various programs described herein, including the administrative software 108, those for content delivery 106, for monitoring 116, and for the interface 112 will typically reside as programs 220 in the memory/memories 208 of one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

As used herein, the term “computer-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory 208, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the method.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

A computer system may also include various peripheral devices 214, including one or more input/output devices such as monitors, keyboards, mice, and any other desired devices.

Some computer systems may include transmission medium 216, which may be referred to as a communication network, that couples various internal components of the computer system. Such a communication network may also be referred to in some implementations as a computer bus. Some computer systems may include a specialized input/output device (e.g., network interface 212) configured to connect to an external communication network 218. The external communication network may include the Internet.

Where a process is described herein, those of skill in the art will appreciate that the process may operate without any user intervention. In another embodiment, the process includes some human intervention (e.g., a step is performed by or with the assistance of a human).

While this invention has been described with respect to an online music subscription service, those skilled in the art will readily appreciate and understand, upon reading this description, that it is applicable to other services and to other forms of content, including digital content in any form and representing pictures, videos, movies, music, books. The invention is applicable to any service and to any content, regardless of its form or how the content is delivered.

As used herein the words “first”, “second”, and so on, when used as adjectives before a term, are merely used to distinguish similar terms, and their use does not imply or define any numerical limits or any ordering (temporal or otherwise). Thus, e.g., the terms “first cohort” and “second cohort” are used to refer to and distinguish between different cohorts.

Thus is described a subscription approach for content delivery, with initial free service based on a parameterized behavioral model. While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed:

1. A method, operable in a content delivery system, the method comprising:
(A) allocating a user a first period of limited free access to content;
(B) monitoring the user's activity during the first period;
(C) assigning the user to a particular cohort of a plurality of cohorts based, at least in part, on the user's activity during the first period, wherein each cohort prescribes one or more conditions governing additional free access by users assigned to that cohort;
(D) allocating the user a usage allowance based at least in part on the conditions prescribed in the particular cohort to which the user was assigned;
(E) enforcing the user's actual usage according to the conditions prescribed in the particular cohort to which the user was assigned; and
(F) after a time period prescribed by the particular cohort to which the user was assigned, providing the user with an opportunity to become a subscriber to the system; and, if the user does not become a subscriber to the system;
(G) adjusting the user's usage allowance based at least in part on the conditions prescribed in the particular cohort to which the user was assigned; and
(H) selectively repeating steps (E) to (H) based at least in part on the conditions prescribed in the particular cohort to which the user was assigned.

2. The method of claim 1 wherein the plurality of cohorts consists of six cohorts.

3. The method of claim 1 wherein the content is streamed audio content.

4. The method of claim 1 wherein the step (C) of assigning the user to a particular cohort of a plurality of cohorts is also based, at least in part, on information about the user.

5. The method of claim 4 wherein the information about the user comprises one or more of: the user's age, the user's sex, the user's geographical location, and the user's income level.

6. The method of claim 1 further comprising:
(I) creating a second plurality of cohorts; and
(J) assigning the user to a second cohort, said second cohort being one of the cohorts in the second plurality of cohorts.

7. The method of claim 6 further comprising:
(K) allocating the user a usage allowance based at least in part on the conditions prescribed in the second cohort;
(L) enforcing the user's actual usage according to the conditions prescribed in the second cohort; and
(M) after a time period prescribed by the second cohort, providing the user with an opportunity to become a subscriber to the system; and, if the user does not become a subscriber to the system;
(N) adjusting the user's usage allowance based at least in part on the conditions prescribed in the second cohort; and
(O) selectively repeating steps (K) to (N) based at least in part on the conditions prescribed in the second cohort.

8. The method of claim 1 further comprising:
(I) creating a second plurality of cohorts;
(J) assigning the user to a second cohort, said second cohort being one of the cohorts in the second plurality of cohorts;
(K) allocating the user a usage allowance based at least in part on the conditions prescribed in the second cohort;
(L) enforcing the user's actual usage according to the conditions prescribed in the second cohort; and
(M) after a time period prescribed by the second cohort, providing the user with an opportunity to become a subscriber to the system; and, if the user does not become a subscriber to the system;
(N) adjusting the user's usage allowance based at least in part on the conditions prescribed in the second cohort; and
(O) selectively repeating steps (K) to (N) based at least in part on the conditions prescribed in the second cohort.

9. The method of claim 8 wherein the content comprises streamed audio content, and wherein the step (C) of assigning the user to a particular cohort of a plurality of cohorts is also based, at least in part, on information about the user, wherein the information about the user comprises one or more of: the user's age, the user's sex, the user's geographical location, and the user's income level.

10. A device configured and programmed to perform the method of claim 1.

11. The device of claim 10 wherein the content comprises streamed audio content, and wherein the assigning of the user to a particular cohort of a plurality of cohorts is also based, at least in part, on information about the user, wherein the information about the user comprises one or more of: the user's age, the user's sex, the user's geographical location, and the user's income level.

12. Computer-readable media tangibly embodying a program of instructions executable by at least one computer, the program comprising code to perform the method of claim 1.

13. Computer-readable media as in claim 12 wherein the content comprises streamed audio content, and wherein the assigning of the user to a particular cohort of a plurality of cohorts is also based, at least in part, on information about the user, wherein the information about the user comprises one or more of: the user's age, the user's sex, the user's geographical location, and the user's income level.
